(19) United States
(12) Patent Application Publication
(10) Pub. No.: US 2016/0254116 A1
(43) Pub. Date: Sep. 1, 2016

(54) METAL ELECTRODE, AND ELECTRON GUN, ELECTRON TUBE, AND X-RAY TUBE USING METAL ELECTRODE

(71) Applicant: Shimadzu Corporation, Kyoto (JP)

(72) Inventors: Masaaki Ukita, Kyoto (JP); Takuro Izumi, Kyoto (JP); Yusuke Koga, Kyoto (JP)

(21) Appl. No.: 15/032,514

(22) PCT Filed: Nov. 19, 2014
(86) PCT No.: PCT/JP2014/080685

§ 371 Date: Apr. 27, 2016

(30) Foreign Application Priority Data
Jan. 29, 2014 (JP) 2014-014494

(51) Int. Cl. H01J 35/14; H01J 35/08; H01J 35/06

(52) U.S. Cl. CPC H01J 35/14; H01J 35/06; H01J 35/08

(57) ABSTRACT

A metal including a passivation film 33a with a thickness of 10 nm or more is used as a metal electrode (a focus cup electrode 33) for generating an electric filed in a vacuum. The focus cup electrode 33 is made of stainless steel. The stainless steel is immersed in a treatment solution to perform coating (passivation treatment) . Accordingly, the passivation film 33a can be formed to be thicker than 10 nm. In this manner, the passivation film 33a is thicker than 10 nm. Therefore, the surface is uniform, and the adhesion is excellent, and the number of pinholes is small. Accordingly, the withstand voltage performance can be improved.

### TECHNICAL FIELD

The present invention relates to a metal electrode that is used in a vacuum, and an electron gun, an electron tube, and an X-ray tube that use the metal electrode.

### BACKGROUND ART

An electron gun, an X-ray tube, and the like are operated by providing a voltage difference between electrodes (for example, a focus cup surrounding a filament and an anode) in a vacuum. In general, an electrode is used which is designed such that an electric field on the surface of the electrode is equal to or less than 10 kV/mm, and which has a polished surface. The electrode is cleaned to prevent foreign substances from depositing thereon. It can be said that the surface of the electrode is made uniform and smooth to prevent the local concentration of the electric field from occurring, which prevents the electrode from discharging. If there is, for example, a minute pinhole on the polished surface other than the foreign substances, a high electric field is generated at a minute corner portion. It becomes a cause of discharge. There are many types of polishing such as mechanical polishing and electrochemical polishing.

However, in many cases, a high voltage where the electric field on the surface of the electrode exceeds 10 kV/mm needs to be continuously applied. Hence, the electrode is required a high withstand voltage characteristic (that is, the electrode that does not discharge). To obtain the high withstand voltage characteristic, the following methods are known.

A. A method is known which performs thorough cleaning by use of a polished electrode. Ultraprecision mirror polishing for polishing the surface of the electrode with a high precision of roughness of approximately 1 nm (Ra) has recently been performed in some cases. An oxide film is spontaneously formed on the polished surface of the metal (a natural oxide film). For example, in a case of “stainless steel” being an alloy containing approximately 10.5% or more chromium in iron, a natural oxide film with a thickness of 1 nm to 3 several nm, 6 nm at the maximum, called a “passivation coating film” or “passivation film” is generated on the surface of the stainless steel. The film is a closely-packed film with high adhesion where mainly oxygen and a hydroxyl group are bound to chromium. The film covers the surface of the metal. The coating film has the property that even if part thereof is removed by a scratch and the like, it is regenerated soon as long as there is oxygen. The coating film protects the stainless steel from a corrosive environment. The stainless steel has excellent corrosion resistance due to the passivation coating film. However, the passivation coating film is destroyed depending on the environment where the stainless steel is placed, and corrosion occurs. In other words, a normal passivation coating film is extremely thin. Accordingly, it is ununiform, and minute pits and pinholes remain. Susceptibility to corrosion is determined by a pitting resistance test (JIS G0578) (refer to http://www.jssa.gr.jp/contents/faq-article/q8/). It is generally said that if the thickness of plating is increased, the number of pinholes is reduced.

B. A method is known which forms an insulating film (for example, an epoxy film) on an electrode.

C. A method is known which deposits a DLC (diamond like carbon) film on a Wehnelt electrode (a focus cup electrode if used for an X-ray tube) by plasma ion implantation (refer to, for example, Patent Document 1).

### Patent Document 1: JP-A-2012-164427

### SUMMARY OF THE INVENTION

### Problems to be Solved by the Invention

However, in the cases of such methods A to C, there are the following problems.

In other words, the method A requires an expensive precision processing machine. Moreover, fine uniform abrasive grains are required for it. Moreover, the shape of the electrode is not flat in many cases. It is not possible to process many electrodes all together at one time. As a result, the cost is high. Furthermore, in the method A, the passivation film on the surface is thin and ununiform. Accordingly, the local concentration of the electric field occurs on the order of several nm. When a high electric field is generated, a discharge occurs.

Moreover, in the method B, the adhesion of the insulating film to the electrode is likely to become insufficient due to variations in manufacture. The insulating film is peeled off from the metal. Furthermore, the heat resistance temperature is low, and high-temperature baking (degassing) and the like cannot be performed. Accordingly, the degree of vacuum is likely to be reduced.

Moreover, in the method C, the film deposition apparatus is expensive, and the film needs to be formed in a vacuum. Accordingly, there is a problem that the throughput is low (although it depends on the size of a vacuum chamber, only several pieces can be treated at a time, and the film deposition time is long). As a result, the cost is high.

The invention has been made considering such circumstances. An objective thereof is to provide a metal electrode that has a uniform surface, is excellent in adhesion, and can improve the withstand voltage performance, and an electron gun, an electron tube, and an X-ray tube that use the metal electrode.

### Solutions to the Problems

To achieve such an objective, the invention adopts the following configuration.

In other words, the metal electrode according to the invention is a metal electrode used in a vacuum, and includes a passivation film having a thickness of 10 nm or more.

[Operation·Effect]

According to the metal electrode of the invention, a metal including a passivation film with a thickness of 10 nm or more (that is, a passivation film that is thicker than a natural oxide film) is used as a metal electrode for generating an electric field in a vacuum. The thickness of the passivation film is 10 nm or more. Accordingly, the surface is more uniform than the natural oxide film, and the adhesion is excellent. The number of minute pinholes is small. Accordingly, it is possible to improve the withstand voltage performance.

Moreover, the metal electrode of the invention is used for an electron gun, an electron tube, and an X-ray tube.

### EFFECTS OF THE INVENTION

According to the metal electrode, and the electron gun, the electron tube, and the X-ray tube that use the metal electrode of the invention, a metal including a passivation film with a thickness of 10 nm or more is used as a metal electrode for generating an electric field in a vacuum to enable an improvement in withstand voltage performance.

### BRIEF DESCRIPTION OF THE DRAWINGS

FIG. 1(a) is a schematic cross-sectional view illustrating the configuration of an X-ray tube according to an embodiment, and FIG. 1 (b) is a schematic cross-sectional view where a focus cup electrode 33 of FIG. 1(a) is enlarged.

FIG. 2 (a) is a potential distribution near the focus cup electrode 33, and FIG. 2 (b) is the potential distribution near the focus cup electrode 33 and an example of the track of an electron beam.

FIG. 3(a) is results of a withstand voltage test (the electric field and the degree of vacuum) in a case of having a passivation film (its thickness is equal to or more than 300 nm and equal to or less than 600 nm), and FIG. 3(b) is results of a withstand voltage test (the electric field and the degree of vacuum) for a comparison in a case of having a passivation film generated by natural oxidization.

### DESCRIPTION OF EMBODIMENT

An embodiment of the invention is described hereinafter with reference to the drawings.

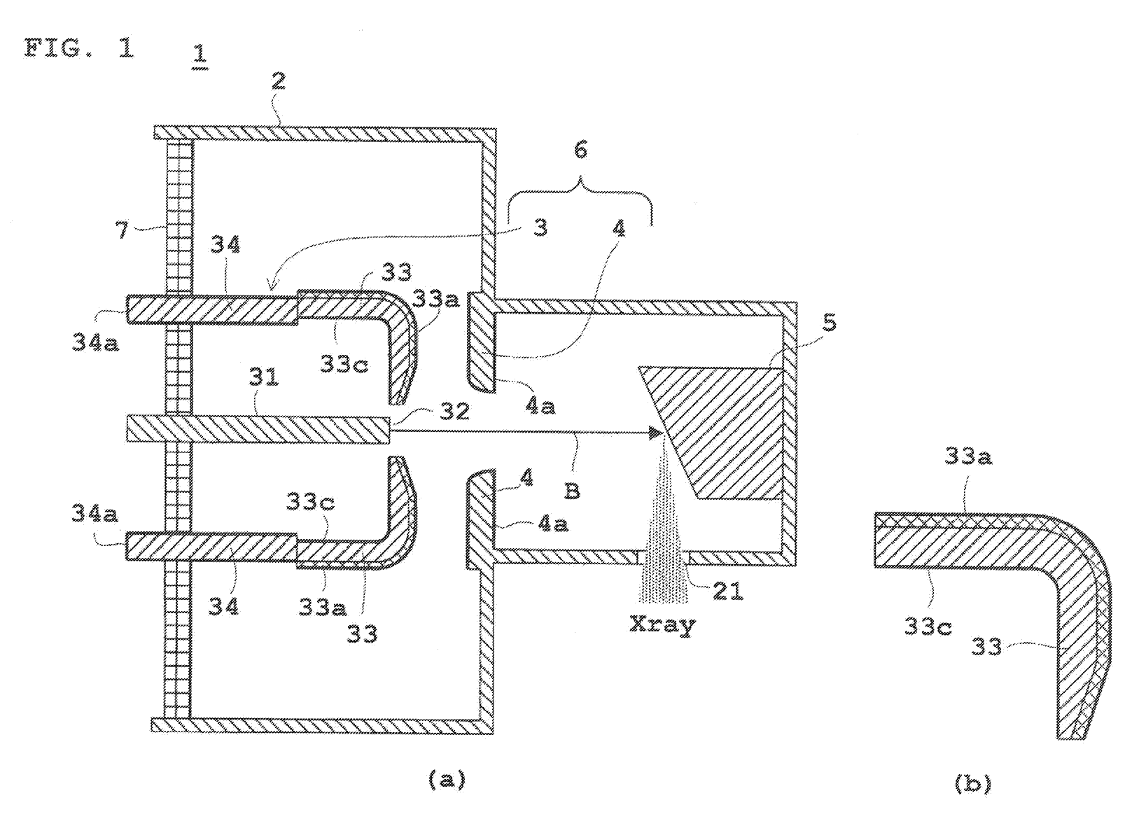

FIG. 1(a) is a schematic cross-sectional view illustrating the configuration of an X-ray tube according to the embodiment.

FIG. 1 (b) is a schematic cross-sectional view where a focus cup electrode 33 of FIG. 1(a) is enlarged.

An X-ray tube 1 illustrated in FIG. 1 (a) includes a vacuum container 2, a cathode 3, an anode 4, and a target 5. The cathode 3, the anode 4, and the target 5 are accommodated in the vacuum container 2.

The cathode 3 generates an electron beam B. The cathode 3 includes an emitter electrode 31, an emission surface 32, the focus cup electrode 33, and a holder portion 34. A bottom portion of the vacuum container 2 is sealed by an insulator 7. The insulator 7 is penetrated by the emitter electrode 31 and the holder portion 34, and is configured to be electrically connectable.

The emitter electrode 31 is illustrated, simplifying a general filament with two terminals. A current is caused to flow between the two terminals to apply heat. Accordingly, thermal electrons (the electron beam B) are emitted from the emission surface 32. Its potential is substantially close to the potential of the focus cup electrode 33.

The focus cup electrode 33 has a shape that surrounds the emitter electrode 31 and the emission surface 32, and has the function of controlling deriving of the electron beam B from the emission surface 32. The focus cup electrode 33 is formed by cutting stainless steel (SUS) into a shape that causes electric field distribution where desired performance can be obtained. A specific configuration of the focus cup electrode 33 (a passivation film 33a of the stainless steel) is described below.

The holder portion 34 is designed to have a low electric field on the surface with respect to the container 2 for the purpose of holding the focus cup electrode 33. The holder portion 34 is made of stainless steel as in the focus cup electrode 33. However, as described below, the thickness of the passivation film 33a of the stainless steel of the focus cup electrode 33 is thicker than 10 nm while the thickness of a passivation film 34a of the stainless steel of the holder portion 34 is 1 nm to 3 several nm, approximately 6 nm at the maximum.

The anode 4 has a positive potential as compared to the cathode 3, and derives the electron beam B emitted from the emission surface 32 of the emitter electrode 31. At this point in time, a potential difference is provided between the focus cup electrode 33 and the anode 4 to control the electron beam B. The electron beam B accelerates toward the anode 4 and is taken out of a hole in the center of the anode 4. When the acceleration voltage is increased to generate high-energy X-rays, the maximum electric field on the surface of the cathode 3 becomes equal to or more than 10 kv/mm. The shape of the electron beam B is designed according to the shape and potential of the electrode. However, a distance between the electrodes needs to be short to narrow the electron beam B. Accordingly, it is customary to be unable to reduce the maximum electric field on the surface of the cathode below 10 kV/mm.

The anode 4 is made of the same stainless steel as the focus cup electrode 33, or tungsten or molybdenum. If the anode 4 is made of the stainless steel, the thickness of a passivation film 4a of the stainless steel of the anode 4 is 1 nm to 3 several nm, approximately 6 nm at the maximum, as in the holder portion 34.

The target 5 generates X-rays (expressed as “Xray” in FIG. 1(a)) based on the collision of the electron beam B. The generated X-rays are emitted to the outside through an X-ray emission window 21 of the vacuum container 2. The X-rays are emitted substantially orthogonal to the electron beam B. Accordingly, the surface of the target 5 is an inclined surface with respect to the electron beam B. The target 5 is made of tungsten, molybdenum, or the like.

The X-ray emission window 21 is provided to the vacuum container 2 to emit the X-rays (Xray) to the outside. In the embodiment, the anode 4 is illustrated as part of the vacuum container 2, and is integral with the vacuum container 2. The vacuum container 2 and the anode 4 may be naturally configured as separate bodies. The cathode 3 and the anode 4 constitute an electron gun 6. The electron gun 6 is an example of the electron gun of the invention.

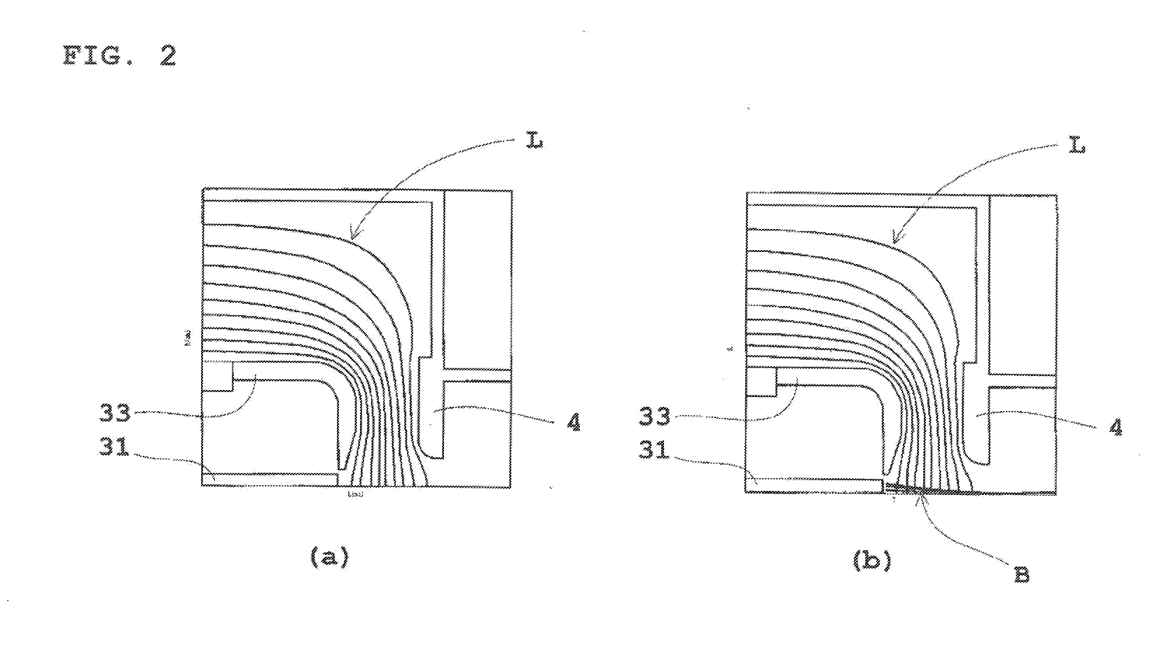

Next, a description is given of the formation of the passivation film 33a of the stainless steel of the focus cup electrode 33 with reference to FIGS. 2(a) and 2 (b) together with the above-mentioned FIGS. 1(a) and 1(b). FIG. 2(a) is a potential distribution near the focus cup electrode. FIG. 2 (b) is the potential distribution near the focus cup electrode and an example of the track of the electron beam. The illustrations of the passivation films are omitted in FIGS. 2(a) and 2(b). A symbol L of FIGS. 2(a) and 2 (b) indicates equipotential lines. An area where spaces between the equipotential lines L are narrow indicates a location where the electric field is strong.

As illustrated in FIGS. 2(a) and 2(b), a space between the focus cup electrode 33 and the anode 4 is narrow, and the spaces between the equipotential lines L are narrow. Accordingly, the electric field is concentrated to generate a high electric field. Therefore, the electrode is likely to discharge. Hence, as illustrated in FIGS. 1(a) and 1(b), the invention has been made, forming the passivation film 33a at least on an outer side of the focus cup electrode 33, the outer side facing the anode 4, to be thicker than 10 nm.

It is preferable that the passivation film 33a be thicker than the natural oxide film, in other words, the thickness of the passivation film 33a be equal to or more than 10 nm. The thickness of the passivation film 33a is preferably equal to or more than 10 nm and equal to or less than 600 nm. The thickness of the passivation film 33a is more preferably equal to or more than 300 nm and equal to or less than 600 nm. This is because the thicker the passivation film 33a, the more advantageous for an improvement in withstand voltage characteristic, but the formation of the passivation film 33a with a thickness of more than 600 nm is difficult. At such a thickness, the oxide film itself is colorless and transparent, but looks like colored due to light interference. Therefore, it is possible to determine the thickness of the passivation film 33a from the color. Moreover, as the passivation film 33a becomes thicker, the surface of the focus cup electrode 33 becomes more uniform, the adhesion (between the focus cup electrode 33 and the passivation film 33a) is further increased, and the number of minute pinholes is reduced. Accordingly, it is possible to further improve the withstand voltage performance.

As also mentioned in the section of “BACKGROUND ART,” stainless steel contains chromium. A passivation film made of chromium oxide is spontaneously formed on the surface of the stainless steel. The thickness of the passivation film is 1 nm to 3 several nm, 6 nm at the maximum. If the holder portion 34 and the anode 4 are made of stainless steel, the passivation film 34a formed on the surface of the holder portion 34 and the passivation film 4a formed on the surface of the anode 4 are spontaneously formed. Their thicknesses are 1 nm to 3 several nm, 6 nm at the maximum.

For the natural oxide film described above, the thickness of the passivation film 33a on the outer side of the focus cup electrode 33, the outer side facing the anode 4, is formed to be equal to or more than 10 nm. To make the thickness of the passivation film equal to or more than 10 nm, the stainless steel is immersed in a treatment solution to perform coating (passivation treatment) . The stainless steel is immersed in the treatment solution to be treated. Accordingly, it also has the effect that the cost is low. Moreover, it is preferable that after the surface on the outer side of the focus cup electrode 33 is electropolished, coating for forming the passivation film 33a be performed. Coating is performed after electropolishing. Accordingly, the surface of the focus cup electrode 33 becomes more uniform, the adhesion (between the focus cup electrode 33 and the passivation film 33a) is further increased, and it is possible to further improve the withstand voltage performance.

Coating (passivation treatment) where stainless steel is immersed in a treatment solution is conventionally performed for the purpose of preventing salt damage and coloring the stainless steel. In the present invention, the above-mentioned coating is focused on to improve the withstand voltage performance of a metal electrode (the focus cup electrode 33 in the embodiment) used in a vacuum. As a result, it has been affirmed from a withstand voltage test that the withstand voltage performance was improved; furthermore, the surface of the metal electrode (the focus cup electrode 33) became uniform, and the adhesion between the metal electrode (the focus cup electrode 33) and a passivation film was improved. The withstand voltage test is described below.

Coating (passivation treatment) where stainless steel is immersed in a treatment solution includes a chemical method and an electrochemical method. In the chemical method, stainless steel is immersed in an oxidizing acid such as nitric acid to form a passivation film. In the electrochemical method, a current is caused to flow in a treatment solution to form a passivation film on stainless steel. In recent years, a fluorine-based passivation film and the like have also been developed (refer to http://www.chemical-y.co.jp/pickup/2009/08/post-6.html).

It is also preferable that another type of insulating film that is different from the passivation film 33a of the focus cup electrode 33 be formed on the passivation film 33a formed in this manner. The insulating film functions as a protective film to enable an improvement in protective properties of the passivation film 33a.

As described above, the electric field is concentrated between the focus cup electrode 33 and the anode 4 to cause a high electric field. Accordingly, it is simply required to make the passivation film 33a at least on the outer side of the focus cup electrode 33, the outer side facing the anode 4, thick. Therefore, the thickness of a passivation film 33c on another surface of the focus cup electrode 33 may be 1 nm to 3 several nm, 6 nm at the maximum, as in the passivation film 34a of the holder portion 34 and the passivation film 4a of the anode 4. In this manner, coating is not required for the other surface of the focus cup electrode 33. Accordingly, there is an advantage that the amount of use of the treatment solution that is used for coating can be suppressed. Naturally, the thickness of the passivation film 33c on the other surface of the focus cup electrode 33 may also be formed similarly to the thickness of the passivation film 33a on the outer side of the focus cup electrode 33. In this case, the need of a mask process on an inner surface is eliminated. Accordingly, the process can be omitted.

To make the passivation film 33a on the outer side of the focus cup electrode 33 thicker than the passivation film 33c on the other surface of the focus cup electrode 33, it is simply required to immerse the focus cup electrode 33 in a treatment solution to perform coating in a manner that the other surface of the focus cup electrode 33 is masked. The passivation film is not formed only on the masked surface during immersion. The passivation film is spontaneously formed on the other surface (that is, the masked surface) of the focus cup electrode 33 before and after immersion.

According to the metal electrode (the focus cup electrode 33 in the embodiment) configured as described above, a metal including a passivation film with a thickness of 10 nm or more, that is, a passivation film that is thicker than a natural oxide film, (the passivation film 33a in the embodiment) is used for the focus cup electrode 33 as a metal electrode for generating an electric filed in a vacuum. The thickness of the passivation film 33a is 10 nm or more. Accordingly, the surface is uniform, and the adhesion is excellent. It is possible to improve the withstand voltage performance.

In the embodiment, coating (passivation treatment) where stainless steel is immersed in a treatment solution is adopted. Accordingly, the stainless steel is simply required to be immersed in the treatment solution for the treatment. There is also the effect that the cost is low.

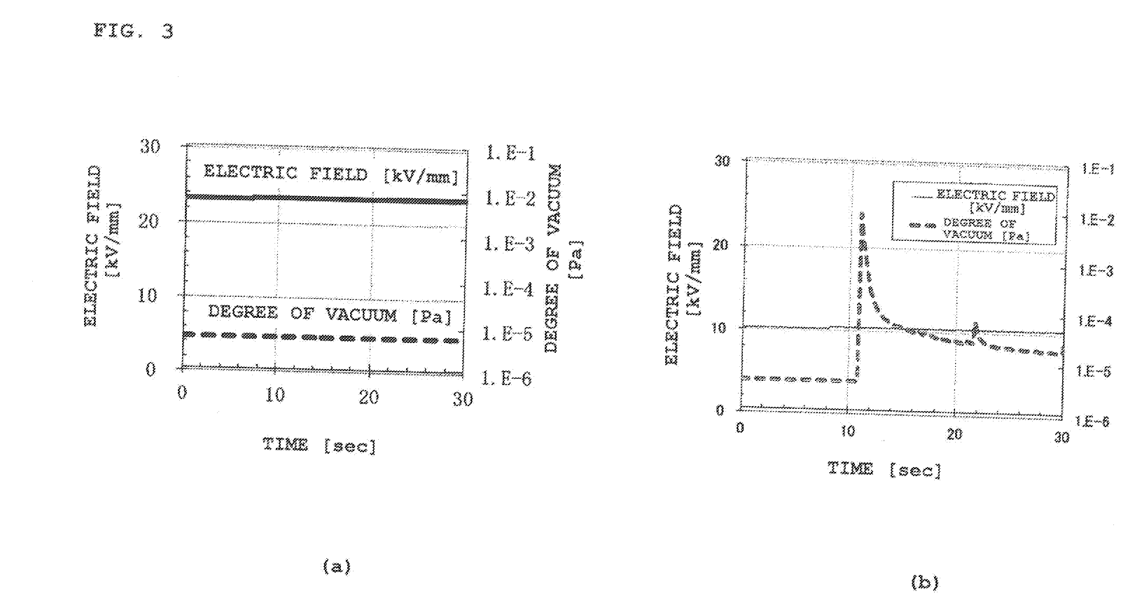

Moreover, in the case of the embodiment, the treatment is performed by immersion in the treatment solution. Accordingly, even if the shape of the electrode (the focus cup electrode 33 in the embodiment) is not flat, the passivation film 33a that is thicker than 10 nm can be formed. Therefore, an expensive precision processing machine and fine uniform abrasive grains are not required as compared to the known method A. Moreover, there is no need to make the electrode (the focus cup electrode 33) flat unlike the method A. Furthermore, the surface becomes uniform in the case of the embodiment as compared to the method A. Accordingly, it has been affirmed from the withstand voltage test (refer to FIG. 3 (a)) that the local concentration of the electric field does not occur, and a discharge does not occur even in a high electric field.

Moreover, in the case of the embodiment, the thickness of the passivation film 33a is equal to or more than 10 nm. Accordingly, as compared to the known method B, the insulating film (here, the passivation film) has sufficiently high adhesion to the electrode (the focus cup electrode 33) and also has heat resistance. As a result, the insulating film (the passivation film) is not peeled off from the electrode (the focus cup electrode 33), either.

Moreover, in the case of the embodiment, stainless steel is treated by being immersed in the treatment solution. Accordingly, the passivation film 33a is formed. Therefore, the need of a vacuum deposition apparatus is eliminated as compared to the known method C. Moreover, stainless steels can be immersed all together in the treatment solution unlike the method C. The throughput is increased.

Moreover, in the case of the embodiment, the metal electrode (the focus cup electrode 33) including the passivation film with a thickness of 10 nm or more is used, integrated into the X-ray tube 1. Accordingly, it has also been affirmed from the withstand voltage test (refer to FIG. 3(a)) that even if a high voltage where an electric field on the surface of the electrode exceeds 10 kV/mm is continuously applied, a discharge does not occur even in the high electric field.

[Withstand Voltage Test]

Next, the results of the withstand voltage test are described with reference to FIGS. 3(a) and 3(b). FIG. 3(a) is results of the withstand voltage test (the electric field and the degree of vacuum) in a case of having a passivation film (its thickness is equal to or more than 300 nm and equal to or less than 600 nm). FIG. 3 (b) is results of a withstand voltage test (the electric field and the degree of vacuum) for a comparison in a case of having a passivation film generated by natural oxidization. If a large discharge occurs, the degree of vacuum (the pressure) is increased due to electron collisions. Accordingly, the state of a discharge was observed based on the degree of vacuum.

As illustrated in FIG. 3 (b) , it can be seen that when there was a passivation film (its thickness is 1 nm to 3 several nm, approximately 6 nm at the maximum) generated by natural oxidation, a discharge did not occur (the degree of vacuum does not change) if the electric field was 10 kV/mm, but a large discharge occurred if the electric field exceeds 11 kV/mm. In other words, if a discharge occurs, the emitted electrons collide with a container wall and the like and detach adsorbed molecules. Accordingly, the degree of vacuum increases. In contrast, as illustrated in FIG. 3(a), it can be seen that when there was a passivation film (its thickness is equal to or more than 300 nm and equal to or less than 600 nm), discharges hardly occurred (the degree of vacuum hardly changed) irrespective of that the electric field is 23 kV/mm that is more than twice the electric field of 10 kV/mm.

The invention is not limited to the above embodiment. Modifications can be made as follows.

(1) In the above embodiment, the metal electrode (the focus cup electrode 33 in the embodiment) including the passivation film with a thickness of 10 nm or more is used, integrated into the X-ray tube 1. However, the application is not limited to the X-ray tube 1. As long as the metal electrode is a metal electrode used in a vacuum and has a structure including a passivation film that is thicker than 10 nm, the metal electrode may be used independently, or an electron gun using the metal electrode or an electron tube using the metal electrode maybe used. The electron gun 6 includes the cathode 3 that generates the electron beam B, and the anode 4 that accelerates the electron beam B from the cathode 2 as illustrated in FIGS. 1(a) and 1(b). The metal electrode including the passivation film with a thickness of 10 nm or more may be applied only to the cathode 3, only to the anode 4, or to both of the cathode 3 and the anode 4. Moreover, the electron tube includes the structure (the vacuum container 2, the cathode 3, and the anode 4), excluding the target 5, of the X-ray tube 1 of FIGS. 1(a) and 1(b). Accordingly, their descriptions are omitted.

(2) In the above-mentioned embodiment, the metal electrode (the focus cup electrode 33 in the embodiment) including the passivation film with a thickness of 10 nm or more is made of stainless steel. The passivation film is chromium oxide. However, the material of the metal electrode is not limited to stainless steel. The passivation film is not limited to chromium oxide, either. As long as it is a metal having a strong ionization tendency, the metal itself dissolves in a non-oxidizing acid (for example, hydrochloric acid), but a passivation film having a thickness of 10 nm or more is formed by an oxidizing acid (for example, nitric acid). Accordingly, the metal electrode is simply required to be made of a metal having a strong ionization tendency. Especially, chromium alone, nickel, and the like are illustrated by example as metals having the withstand voltage performance. If the metal electrode is made of nickel, the passivation film is the oxide of nickel (nickel oxide).

(3) In the above-mentioned embodiment, after electropolishing is performed on the metal electrode (the focus cup electrode 33 in the embodiment) including the passivation film with a thickness of 10 nm or more, coating where the passivation film (the passivation film 33a in FIGS. 1(a) and 1 (b)) made of chromium oxide is formed is performed. However, the performance of electropolishing is not necessarily required.

(4) In the above-mentioned embodiment, as illustrated in FIGS. 1(a) and 1(b), another type of insulating film that is different from the passivation film 33a of the metal electrode (the focus cup electrode 33 in the embodiment) is included on the passivation film 33a. However, the inclusion of the insulating film is not necessarily required.

(5) In the above-mentioned embodiment, the metal electrode including the passivation film with a thickness of 10 nm or more is used as the cathode 3 (especially the focus cup electrode 33 of the cathode 3). However, if the concentration of the electric field may occur at an electrode other than the cathode, or an electrode may be used in a high electric field, the metal electrode may be applied to an electrode other than the cathode. For example, in the case of the application to the anode, a passivation film with a thickness of 10 nm or more is formed on the anode.

(6) In the above-mentioned embodiment, the anode and the target are configured separately. However, a structure is also acceptable in which the anode and the target are integrated.

### INDUSTRIAL APPLICABILITY

As described above, the invention is suitable for a metal electrode used in a vacuum, and an electron gun, an electron tube, and an X-ray tube that use the metal electrode.

### DESCRIPTION OF REFERENCE SIGNS

1 X-ray tube
2 Vacuum container
3 Cathode
33 Focus cup electrode
33a Passivation film (thicker than a natural oxide film)
4 Anode
5 Target
6 Electron gun
B Electron beam

1-11. (canceled)

12. An X-ray tube comprising:
a vacuum container;
an emitter electrode, accommodated in the vacuum container, for generating an electron beam;
a focus cup electrode accommodated in the vacuum container and formed in such a manner as to surround the emitter electrode;
an anode, accommodated in the vacuum container and placed in such a manner as to face the focus cup electrode, for accelerating an electron beam from the emitter electrode; and
a target, accommodated in the vacuum container, for generating X-rays based on collision of the electron beam from the anode, wherein
a passivation film having a thickness of 10 nm or more is formed on a surface of the focus cup electrode, the surface facing the anode.

13. The X-ray tube according to claim 12, wherein
an electric field is concentrated between the focus cup electrode and the anode, and
the passivation film serves a withstand voltage function.

14. The X-ray tube according to claim 12, wherein
the focus cup electrode comprises stainless steel, chromium, or nickel, and
the passivation film is chromium oxide, or the passivation film is nickel oxide.

15. The X-ray tube according to claim 12, wherein the thickness of the passivation film is equal to or more than 10 nm and equal to or less than 600 nm.

16. The X-ray tube according to claim 12, wherein the thickness of the passivation film is equal to or more than 300 nm and equal to or less than 600 nm.

17. The X-ray tube according to claim 12, further comprising, on the passivation film, an insulating film different from the passivation film of the focus cup electrode.

18. The X-ray tube according to claim 12, wherein the passivation film is thicker than a natural oxide film.

19. The X-ray tube according to claim 12, wherein coating for forming the passivation film is performed after electropolishing is performed on the focus cup electrode.

20. An X-ray tube comprising:
a vacuum container;
an emitter electrode, accommodated in the vacuum container, for generating an electron beam;
a focus cup electrode accommodated in the vacuum container and formed in such a manner as to surround the emitter electrode;
an anode, accommodated in the vacuum container and placed in such a manner as to face the focus cup electrode, for accelerating an electron beam from the emitter electrode; and
a target, accommodated in the vacuum container, for generating X-rays based on collision of the electron beam from the anode, wherein
a passivation film having a thickness thicker than a natural oxide film is formed on a surface of the focus cup electrode, the surface facing the anode.

21. The X-ray tube according to claim 20, wherein
an electric field is concentrated between the focus cup electrode and the anode, and
the passivation film serves a withstand voltage function.

22. The X-ray tube according to claim 20, wherein
the focus cup electrode comprises stainless steel, chromium, or nickel, and
the passivation film is chromium oxide, or the passivation film is nickel oxide.

23. The X-ray tube according to claim 20, further comprising, on the passivation film, an insulating film different from the passivation film of the focus cup electrode.

24. The X-ray tube according to claim 20, wherein coating for forming the passivation film is performed after electropolishing is performed on the focus cup electrode.
